(19) United States
(12) Patent Application Publication
(10) Pub. No.: US 2005/0172273 A1
(43) Pub. Date: Aug. 4, 2005

(54) Software and method for automatic renumbering in a document

(76) Inventors: Anthony Gabriel Volini, Oak Park, IL (US); Douglas Rogers, Frankfort, IL (US)

Correspondence Address: Anthony G. Volini;McCracken & Frank LLP, Suite 2150, 200 W. Adams, Chicago, IL, 60606, US

(21) Appl. No.: 10/769,825

(22) Filed: Feb. 2, 2004

(51) Int. Cl. G06F 9/45

(52) U.S. Cl. 717/136

(57) ABSTRACT

A computer readable medium having code for automatic renumbering of patent claims includes a first identification component that identifies a series of claim numbers wherein the claim numbers are integers. A second identification component identifies a series of reference numbers that reference particular claim numbers of the series. A renumbering routine renumbers particular of the claim numbers and reference numbers in an automated fashion without the need for a user to renumber the claim and reference numbers individually.

### TECHNICAL FIELD

The present invention relates generally to document editing software, and more particularly to editing software that automatically renumbers claims.

### BACKGROUND ART

Patents in the United States and in other countries generally conclude with a series of claims, and each claim may be regarded as a succinct definition of the patentee's invention. Quite often, the quantity of claims in a patent application or other patent document may range anywhere from 10 claims to perhaps 50 or more. At any given time during the drafting of the claims, a patent attorney or agent (hereinafter the “practitioner”) may have a series of claims, such as 20 claims for example. The practitioner might insert a new claim within the series. After adding such new claim, the practitioner must then renumber all of the claim numbers after the new claim and must also renumber any dependency reference numbers as necessary. This renumbering effort can become quite time consuming, especially if the practitioner is repeatedly adding or deleting claims in the series.

The most current version of MICROSOFT WORD® word processing software includes a cross-reference feature and automatic list feature that when used together can facilitate re-numbering of claims. However, the cross reference feature requires the practitioner to individually highlight each dependency reference number in order for the cross reference feature to function. Given the value of the practitioner's time, such individual highlighting of numbers may prove inefficient and tiring.

### SUMMARY OF THE INVENTION

In accordance with one aspect of the present invention, a computer readable medium having code for automatic renumbering of patent claims includes a first identification component that identifies a series of claim numbers wherein the claim numbers are integers. A second identification component identifies a series of reference numbers that reference particular claim numbers of the series. A renumbering routine renumbers particular of the claim numbers and reference numbers in an automated fashion without the need for a user to renumber the claim and reference numbers individually.

According to a further aspect of the present invention, a computer assisted method of automatically renumbering patent claims includes the step of obtaining a code having one or more identification components and a renumbering routine. The one or more identification components are used to identify a series of claim numbers and a plurality of dependency reference numbers associated with particular claim numbers of the series in a document wherein the claim numbers and reference numbers are integers. The quantity of claims within the series is changed. The claim numbers and any reference numbers are renumbered with the renumbering routine in response to the change while maintaining the cross-referencing of the dependency reference numbers in an automated fashion without the need for a user of the method to individually renumber the claim numbers and the reference numbers within the series.

A further aspect of the present invention comprehends a method of providing software for automatic renumbering of patent claims to a consumer. A code is provided having one or more identification components that identify a series of claim numbers and a plurality of dependency reference numbers that reference particular claim numbers in the series and a renumbering routine that responds to a change in the series wherein the renumbering routine renumbers claim numbers of the series and renumbers particular dependency reference numbers as necessary to preserve the referencing relationship of the claim numbers and reference numbers prior to the change and wherein the claim numbers are integers. A website is provided for distribution of the code to the consumer. The code is delivered to the consumer.

Other aspects and advantages of the present invention will become apparent upon consideration of the following detailed description.

### BRIEF DESCRIPTION OF THE DRAWINGS

FIGS. 1A and 1B illustrate a display before and after hitting an insert claim button;

FIGS. 2A and 2B illustrate a display before and after hitting a delete claim button;

FIGS. 3 and 4 are software logic diagrams;

FIGS. 5 and 6 are more specific embodiments for carrying out the logic of FIGS. 3 and 4; and

FIGS. 7 and 8 are further logic diagrams.

### DESCRIPTION OF THE PREFERRED EMBODIMENTS

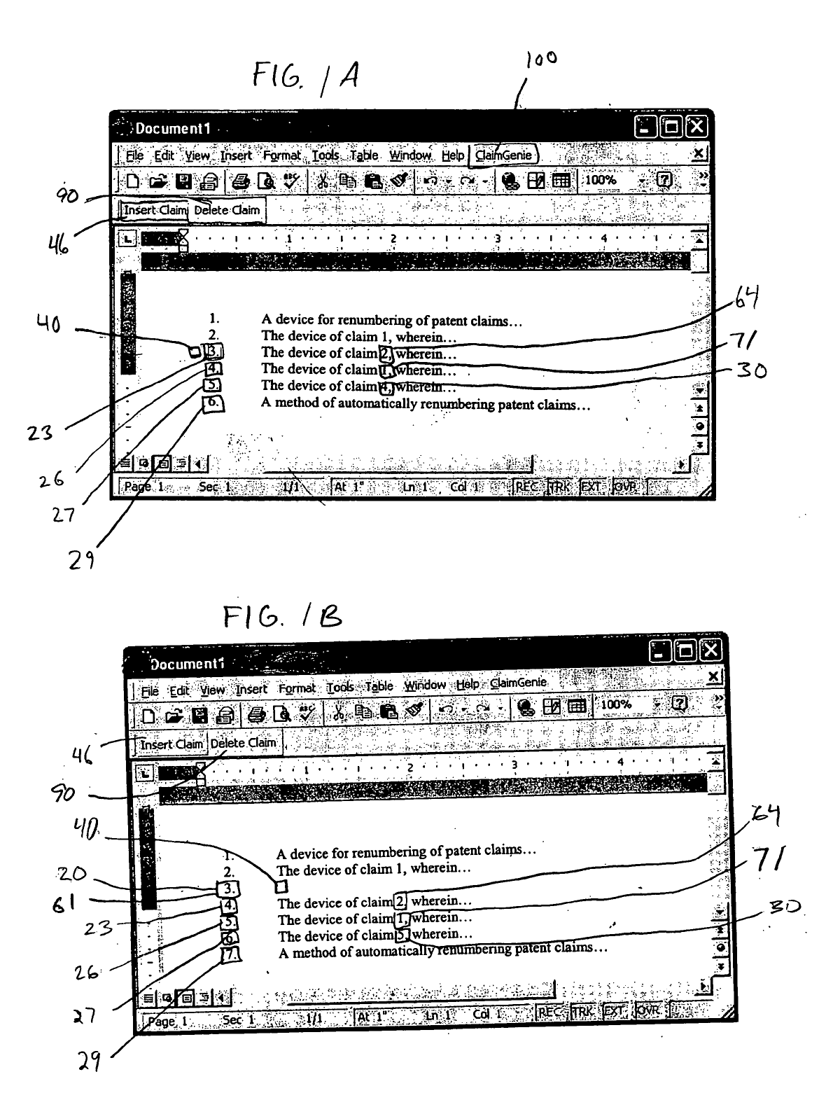

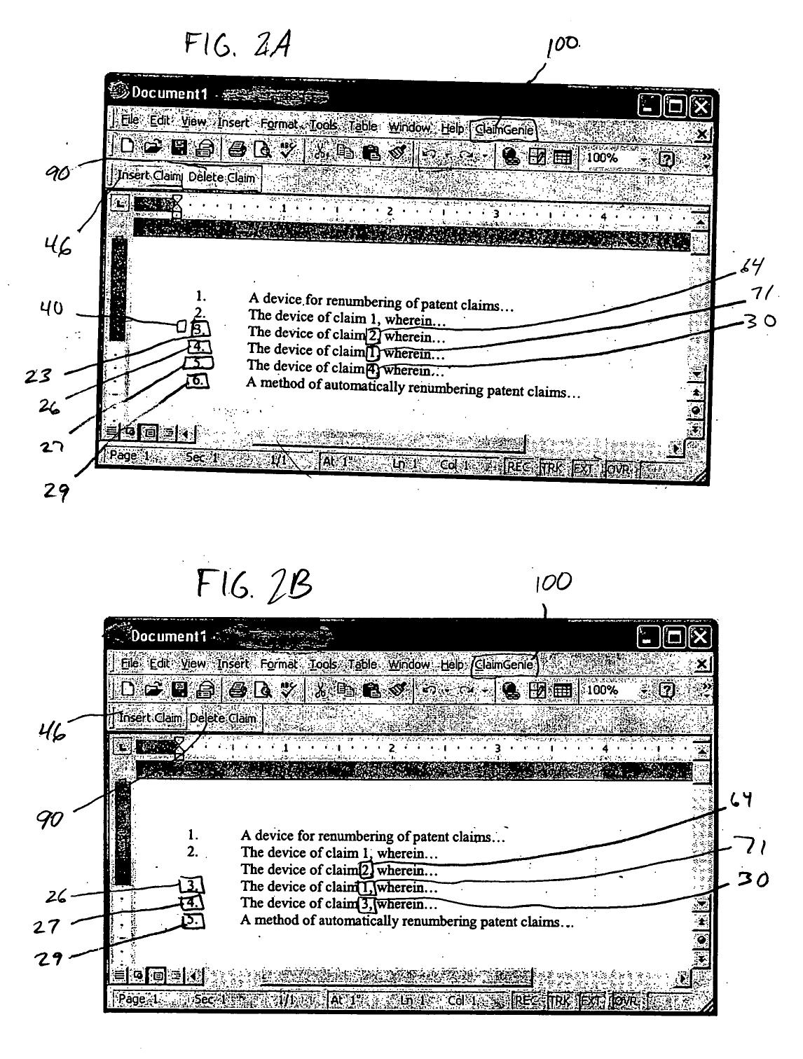

FIG. 1A shows a series of claims having a quantity of 6 claims on a document. Referring to FIG. 1B, a claim 20 is added within the series such that subsequent claims 23, 26, 27, 29 are renumbered, increasing each of these numbers by one. In addition, a dependency reference number 30 is renumbered by increasing the number 30 by one. FIG. 2A shows the same series of claims prior to deleting the claim 23 from the series. Referring to FIG. 2B, the claims 26, 27, 29 are renumbered by decreasing each of these numbers by one. Also, the reference number 30 is renumbered by decreasing the number 30 by one. In the absence of a program of the type discloses herein, the numbers 23, 26, 27, 29, and 30 are typically renumbered by a patent practitioner or perhaps by an assistant of the practitioner.

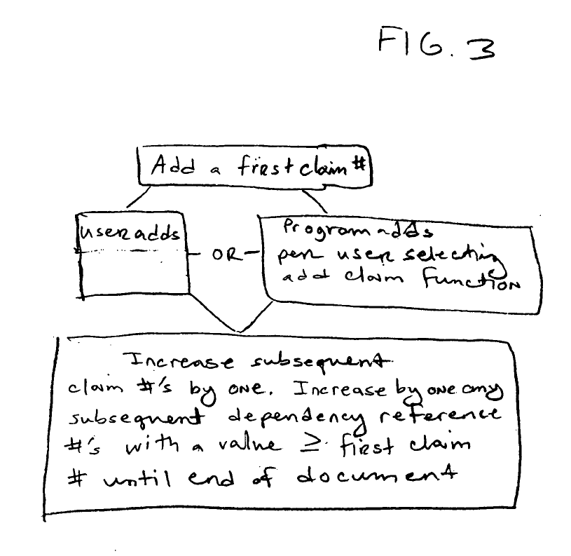

FIG. 3 generally illustrates the logic of a software program that automatically performs the renumbering shown in FIG. 1B. First, a first claim number, such as the claim number 20, is added within the series. The first claim number 20 may be added by the user, or alternatively, the program adds the first claim number 20 upon the user prompting the program to do so as discussed in greater detail hereinbelow. Upon adding the first claim number 20 within the series, the program increases any subsequent claim numbers, such as the numbers 23, 26, 27, 29 by one. In addition, the program increases by one any subsequent dependency reference numbers having a value greater than or equal to the first claim number until the end of the document or series of claims.

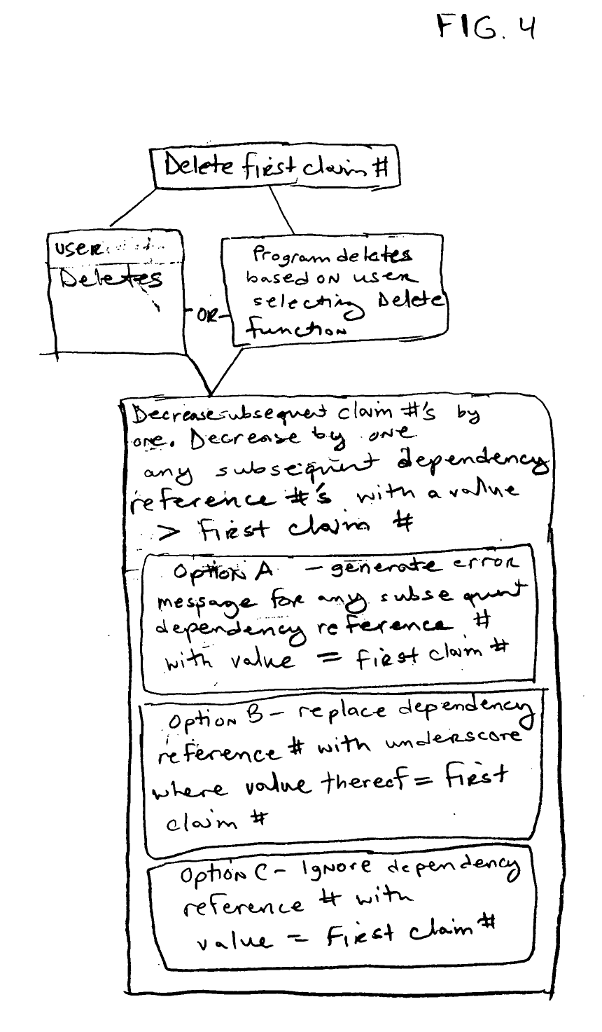

FIG. 4 generally illustrates the logic of a software program that automatically performs the renumbering shown in FIG. 2B. Upon a deletion of the claim number 23, whether the deletion is performed by the user manually deleting the claim number 23 or the user prompting the program to do so, the program decreases the subsequent claim numbers 26, 27, 29 by one. Also, the program decreases by one any subsequent dependency reference numbers, such as the number 30, where the value of the subsequent dependency reference number is greater than the claim number 23. Where any subsequent dependency reference number has a value equal to the deleted first claim number, the program may perform different functions in response to this possibility. One option, labeled option C, is for the program to do nothing, ignoring any such dependency reference number and continuing the renumbering process. Option A involves generating some form of error message indicating to the user of the situation and perhaps asking the user whether the program should perform the renumbering. Option B could include replacing the reference number with an underscore or perhaps with the word “ERROR.”

To execute the logic of FIGS. 3 and 4, a program may utilize a first identification component that identifies claim numbers and a second identification component that identifies dependency reference numbers and a renumbering routine that renumbers subsequent claim numbers and any dependency reference numbers within the series in order to preserve the cross referencing relationship of such numbers prior to the change.

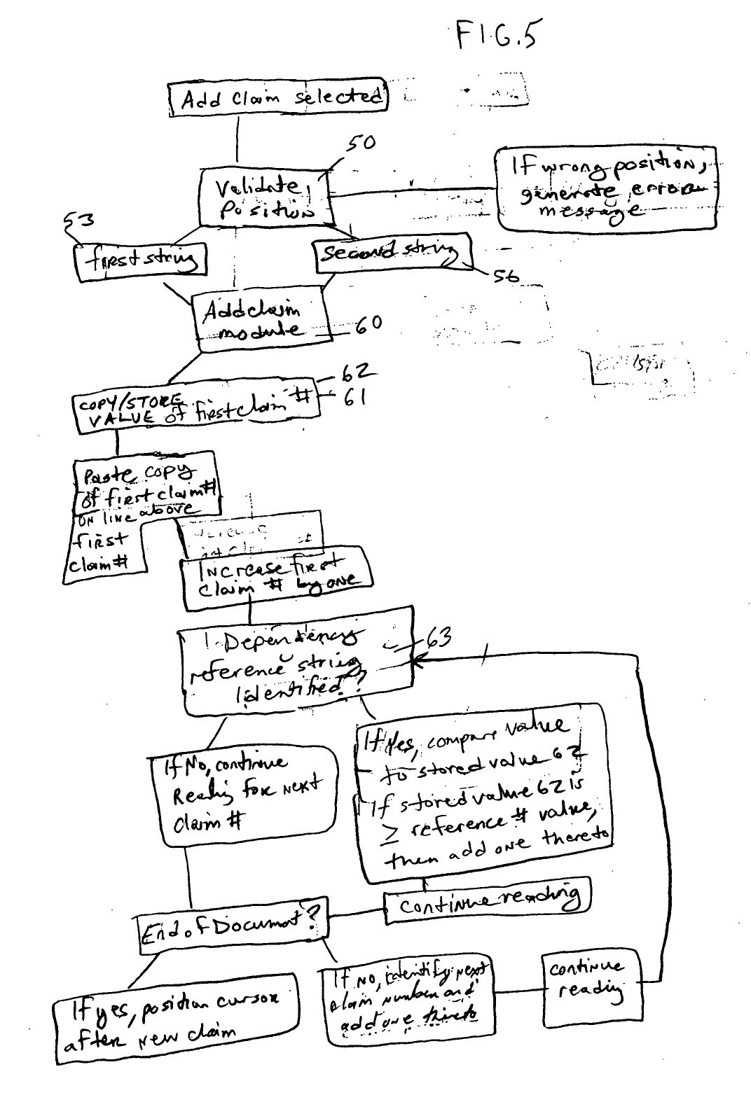

Referring again to FIGS. 1A and 1B, to insert a new claim, a user positions a cursor 40 before the claim 23. A user then selects or hits an insert claim button 46. Referring to FIG. 5, upon selecting the button 46, the program performs a cursor position validation routine 50 to validate that the cursor 40 is positioned before a claim number. The cursor validation routine 50 reads the first three characters/spaces following the cursor position for a first string 53. The first string 53 may be an integer followed by a period, followed by at least one tab (i.e., “#.tab”). The routine 50 could alternatively or additionally read for a second string 56 such as an integer followed by a period, followed by at least one space (i.e., “#.space”) to validate that the cursor 40 is properly positioned before a claim number. If neither of the first and second strings 53, 56 is identified, the program may generate and display an error message indicating that the user needs to position the cursor 40 adjacent a claim number in order to effect an insert claim function.

After the routine 50 validates the cursor position, an add claim module 60 makes a copy 61 of the claim number 20 and stores a value of the claim number 20, which value happens to be the integer 3 in this particular example. The module 60 then pastes the copy 61 along with one or more carriage returns at the position of the cursor shown in FIG. 1A so that the copy 61 appears on a line above the claim number 23. The module 60 then increases the claim number 23 by one. The module 60 next reads for a third string 63 to identify a subsequent dependency reference number 64 after the claim number 23. The third string 63 could be the word “claim” followed by an integer within five or fewer characters/spaces after “claim.” Upon identifying the reference number 64, the program compares the stored value 62 to the value of the reference number 64. If the stored value 62 is greater than the value of the reference number 64, then the module 60 continues reading without changing the number 64. The module 60 next encounters the subsequent claim number 26 by identifying either of the strings and then increases the subsequent claim number 26 by one. The module 60 next encounters a reference number 71 and compares the stored value 62 to the value of the reference number 71. Because the number 71 is less than the stored value 62, the module 60 does not change the value of the number 71 and continues reading. The module 60 next identifies and increases the next subsequent claim number 27 by one. Then, the module 60 identifies the next reference number 30 and compares the stored value 62 to the value of the number 30. The module 60 increases by one any dependency reference number having a value greater than or equal to the stored value 62. Because the value of the reference number 30 is greater than the stored value 62 (i.e., greater than 3), the module 60 increases the reference number 30 by one as shown in FIG. 1B. The module 60 next identifies and increases by one the next subsequent claim number 29. When the module 60 reaches the end of the last line of the document, the module positions the cursor 40 after the newly inserted claim 61. The module 60 may accomplish this cursor positioning by returning to the first line of the document and then reading for a claim number having a value equal to the stored value 62. In this example, the claim number 61 has a value of 3, which is equal to the stored value 62. Therefore, the module 60 places the cursor 40 after the claim number 61.

Referring to FIGS. 2A and 2B, to delete a claim the user positions the cursor 40 before the claim number 23 and then hits a delete claim button 90. Upon hitting the delete claim button 90, a delete claim module 93 (shown in FIG. 4) performs the cursor validation routine 50 as described above. The module 90 then stores the value 62 of the claim number 23 and then deletes the claim number 23. The module 90 may leave the text of the deleted claim so that the user has the option of either moving the text to another location in the document or deleting the text. The module 90 then continues reading until identifying the subsequent claim number 26. The module 90 then decreases the claim number 26 by one. The module 90 next identifies the reference number 71, compares the stored value 62 to the value of the reference number 23, and continues reading because the number 71 is less than the stored value 62. However, the value of the reference number 30 is greater than the stored value 62. So, the module 90 decreases the reference number 30 by one, from the value shown in FIG. 2A to the value shown in FIG. 2B. If the module 90 identifies a reference number having a value equal to the stored value, then the module 90 preferably displays an error message to the user indicating that claim number being deleted has one or more reference numbers dependent thereon. Such message might ask the user whether she would like to cancel the delete function or continue anyway.

The program could further include a toolbar button 100. The user may hit the button 100 and then select an about button (not shown) that provides any desired information such as licensing information or information regarding how the program operates. In addition, hitting the button 100 may reveal a settings button (not shown) that allows the user to select from two different operating settings. A first of these settings could be described as a high accuracy setting, which requires at least one tab following each period after the claim number. In the high accuracy setting, the cursor position validation routine 50 searches exclusively for the string 53 to identify claim numbers. An advantage of the high accuracy setting should be evident when one considers an exemplary chemical claim, the text of which ends in a number followed by a period and a space—e.g., “wherein the component includes a molecular weight of 50.[space]” For such a claim, the high accuracy setting will not undesirably increase or decrease the integer 50 by one. A second possible setting is a universal setting which identifies claim numbers by either of the strings 53, 56. An advantage of the universal setting is that the user need not include a tab after each claim and could have either a space or a tab, or combinations thereof, after each period following the claim number. The universal setting has the advantage of functioning with a greater variety of claim formats.

If the program is for use in the most current version of MICROSOFT WORD® word processing software, then the program is preferably installed into the MICROSOFT WORD start up folder. In this regard, the program preferably includes an auto-install routine that is activated upon a user launching MICROSOFT WORD® from her desktop. The auto-install routine installs the buttons 46, 90, and 100. The program also preferably includes an auto-delete routine that deletes the buttons 46, 90, 100 upon the user exiting MICROSOFT WORD®.

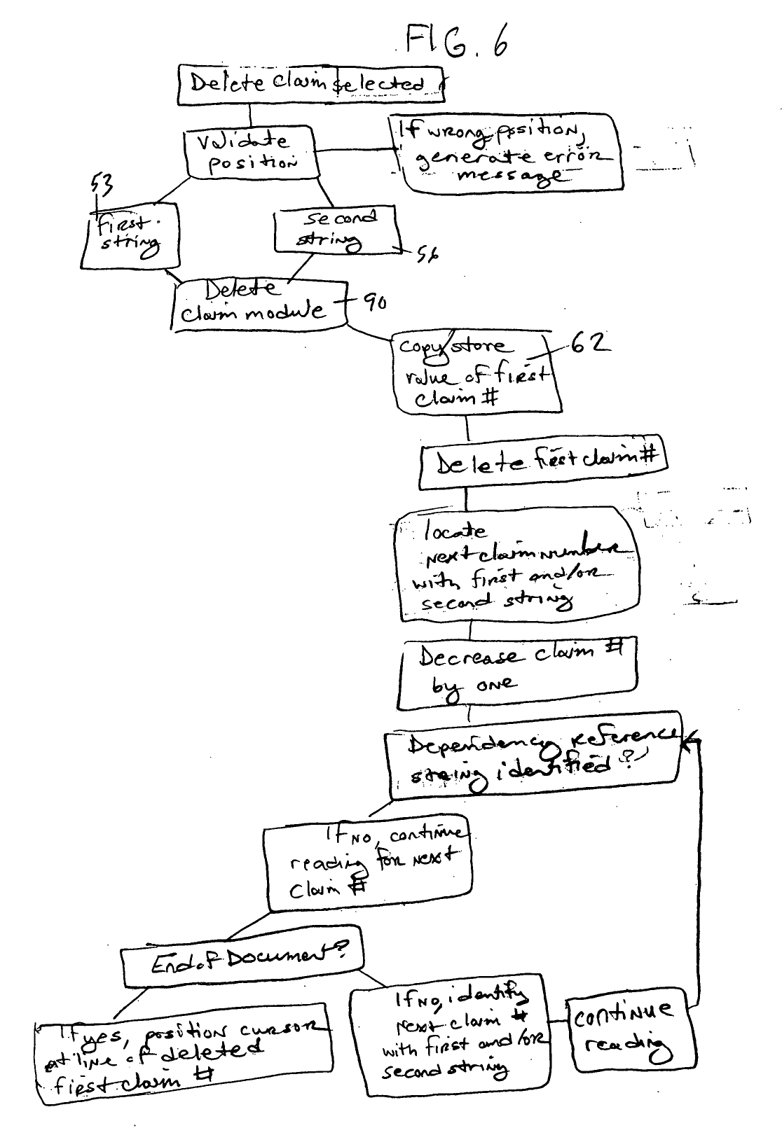

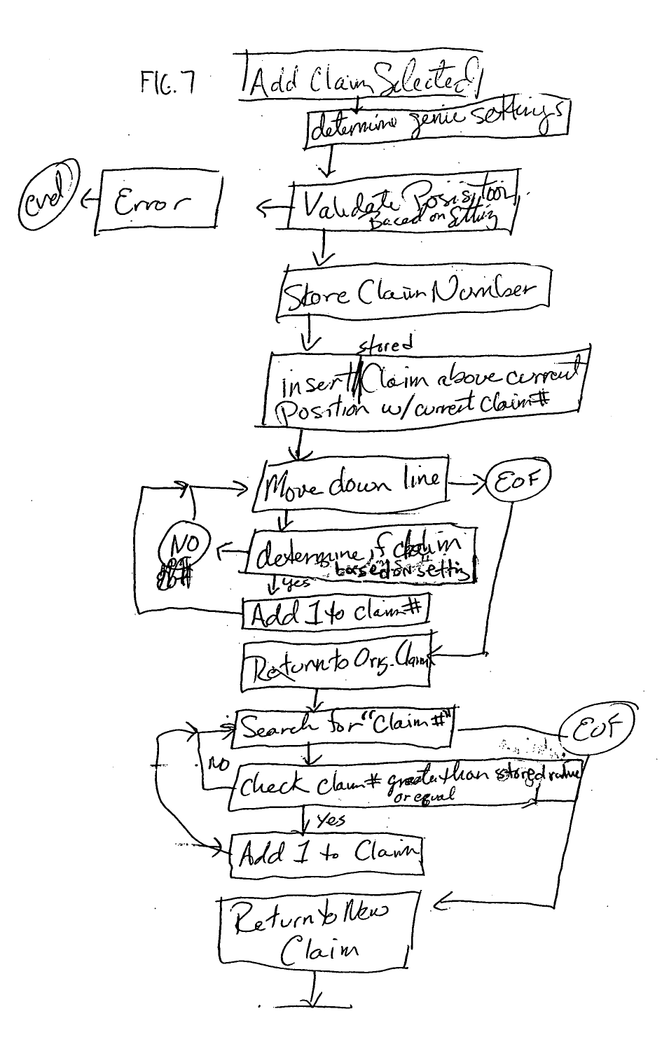

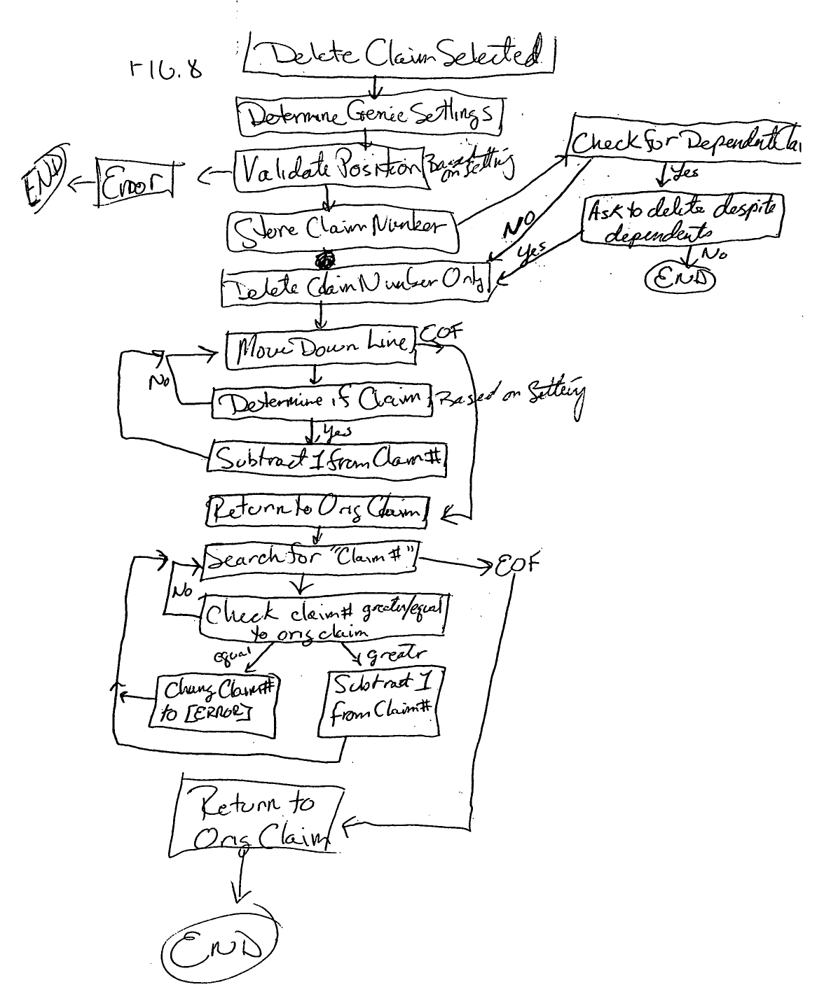

FIGS. 7 and 8 show further logic diagrams for renumbering of claims for an add claim function and a delete claim function, respectively. In FIG. 7, for an insert claim function, the program first determines which setting the user has selected (e.g., universal or high accuracy). The program validates the cursor position based on the setting. The program stores the claim number. Next, the program inserts the stored claim number along with one or more carriage returns at the cursor position. The program next reads each line of the document for subsequent claim numbers based on the setting. If a subsequent claim number is found the program adds one to the claim number. After all claim numbers are identified and increased by one, the program returns to the original cursor position and searches for the third string 63 for reference numbers. If the line of the document has the third string 63, the program adds one to the claim number. When the program reaches the end of the file (EOF), the program returns the cursor to the new claim. FIG. 8 shows a similar logic diagram for deleting a claim number. It should be noted that unlike the logic diagrams of FIGS. 5 and 6, the diagrams of FIGS. 7 and 8 first read all lines of the documents for claim numbers, then return to the cursor position of where the new claim was inserted or where a claim was deleted, and then the program reads all of the lines again for reference numbers.

The program could be provided to a user's computer by downloading the code over the internet. One could provide a code that performs the above discussed functions and establish a website from which a user could download such code onto his machine. Alternatively, a user could request physical delivery of the code on a suitable medium, other than a CPU, such as a compact or floppy disc.

Numerous modifications to the present invention will be apparent to those skilled in the art in view of the foregoing description. For example, the renumbering program could utilize claim number fields and dependency reference number fields rather than scanning lines of the document to identify same, and perform the same function in different ways known to those of skill in the art. Accordingly, this description is to be construed as merely exemplary of the inventive concepts taught herein and is presented for the purpose of enabling those skilled in the art to make and use the invention and to teach the best mode of carrying out same. The exclusive rights to all modifications which come within the scope of the appended claims are reserved.

1. A computer readable medium having code for automatic renumbering of patent claims, comprising:
a first identification component that identifies a series of claim numbers wherein the claim numbers are integers;
a second identification component that identifies a series of reference numbers that reference particular claim numbers of the series; and
a renumbering routine that renumbers particular of the claim numbers and reference numbers in an automated fashion without the need for a user to renumber the claim and reference numbers individually.

2. The code of claim 1, wherein the renumbering routine is an add claim routine.

3. The code of claim 1, wherein the renumbering routine is a delete claim routine.

4. The code of claim 1, wherein the code enables the display of an add claim button on a computer display.

5. The code of claim 1, wherein a new claim number is added within the series and wherein the reference numbers subsequent to the new claim number are increased by one.

6. The code of claim 5, wherein the subsequent reference numbers have a value greater than or equal to the new claim number.

7. The medium of claim 1, wherein upon deletion of one of the claims within the series, claim numbers subsequent to the one claim are decreased by one and subsequent of the reference numbers are decreased by one.

8. The code of claim 7, wherein the subsequent of the reference numbers decreased by one have a value greater than the one deleted claim number.

9. The code of claim 4, wherein the code on the medium enables the display of a delete claim button on a computer display.

10. The code of claim 1, wherein code on the medium is downloaded into a word processing program.

11. The code of claim 1, wherein the code on the medium identifies the claim numbers and the reference numbers by searching for first and second strings, respectively.

12. The code of claim 11, wherein the first string includes an integer, followed by a period, followed by at least one space.

13. The code of claim 11, wherein the first string includes an integer, followed by a period, followed by at least one tab.

14. The code of claim 11, wherein the second string includes the word “claim” and an integer follows the word claim within less than five characters after the word claim.

15. The code of claim 11, wherein the second string is inputted by the user.

16. The medium of claim 1, wherein the medium is memory.

17. The medium of claim 1, wherein the medium is a compact disc.

18. The medium of claim 1, wherein the medium is a floppy disk.

19. The medium of claim 1, wherein the code thereof includes a validate position routine that validates whether a cursor is positioned adjacent a claim number.

20. A computer assisted method of automatically renumbering patent claims, the method comprising the steps of:
obtaining a code having one or more identification components and a renumbering routine;
using the one or more identification components to identify a series of claim numbers and a plurality of dependency reference numbers associated with particular claim numbers of the series in a document wherein the claim numbers and reference numbers are integers;
changing the quantity of claims within the series; and
renumbering claim numbers and any reference numbers with the renumbering routine in response to the change while maintaining cross-referencing of the dependency reference numbers in an automated fashion without the need for a user of the method to individually renumber the claim numbers and the reference numbers within the series.

21. The method of claim 20, wherein the method is performed in conjunction with a word processor program.

22. The method of claim 21, wherein the claim numbers and any reference numbers are changed by selecting an add claim button.

23. The method of claim 21, wherein the claim numbers and any reference numbers are changed by selecting a delete claim button.

24. A method of providing software for automatic renumbering of patent claims to a consumer, the method comprising the steps of:
providing a code having one or more identification components that identify a series of claim numbers and a plurality of dependency reference numbers that reference particular claim numbers in the series and a renumbering routine that responds to a change in the series wherein the renumbering routine renumbers claim numbers of the series and renumbers particular dependency reference numbers as necessary to preserve the referencing relationship of the claim numbers and reference numbers prior to the change and wherein the claim numbers are integers;
providing a website for distribution of the code to the consumer; and
delivering the code to the consumer.

25. The method of claim 24, wherein the code is delivered to the consumer over the internet.

26. The method of claim 24, wherein the code is disposed on a medium and the medium is physically delivered to the consumer.
